(19) United States
(12) Patent Application Publication
(10) Pub. No.: US 2025/0138407 A1
(43) Pub. Date: May 1, 2025

(54) OPTICAL SYSTEM, STEREO OPTICAL SYSTEM, STEREO IMAGING APPARATUS, IMAGING APPARATUS, AND IMAGE PROJECTION APPARATUS

(71) Applicant: Panasonic Intellectual Property Management Co., Ltd., Osaka (JP)

(72) Inventors: Takuya IMAOKA, Kanagawa (JP); Hiroaki OKAYAMA, Nara (JP)

(21) Appl. No.: 18/987,771

(22) Filed: Dec. 19, 2024

Related U.S. Application Data
(63) Continuation of application No. PCT/JP2023/006779, filed on Feb. 24, 2023.

(30) Foreign Application Priority Data
Jun. 28, 2022 (JP) 2022-103629

(51) Int. Cl. G03B 35/10; G02B 30/35; G03B 35/22

(52) U.S. Cl. CPC G03B 35/10; G02B 30/35; G03B 35/22

(57) ABSTRACT

The present disclosure is directed to an optical system having a reduction conjugate point on a reduction side and a magnification conjugate point on a magnification side, the optical system comprising: a prism including a first transmission surface located on the magnification side, a second transmission surface located on the reduction side, and at least three reflection surfaces located on an optical path between the first and second transmission surfaces; wherein the at least three reflection surfaces include first and second reflection surfaces in order from the magnification side to the reduction side, and a most reduction-side reflection surface located closest to the reduction side, wherein an intermediate imaging position related with both the reduction and magnification conjugate points is positioned inside the prism, and wherein the first reflection surface is positioned in a region where a plurality of principal rays traveling inside the prism are converged on.

### CROSS-REFERENCE TO RELATED APPLICATIONS

This application is a continuation of International Patent Application No. PCT/JP2023/006779, filed on Feb. 24, 2023, which claims the benefit of Japanese Patent Application No. 2022-103629, filed on Jun. 28, 2022, the contents all of which are incorporated herein by reference.

### TECHNICAL FIELD

The present disclosure relates to an optical system using a prism. The present disclosure also relates to a stereo optical system and a stereo imaging apparatus using such an optical system. The present disclosure also relates to an imaging apparatus and an image projection apparatus using such an optical system.

### BACKGROUND ART

Patent Document 1 discloses an image-formation optical system including a prism integrally provided with an incident surface, reflection surfaces and an emitting surface.

### PRIOR ART

[Patent Document 1] JP 2000-231060 A

The present disclosure provides an optical system that can be manufactured with a smaller number of parts, wherein the size and height thereof can be reduced, and a wide-angle design can be easily achieved. The present disclosure also provides a stereo optical system and a stereo imaging apparatus using such an optical system. The present disclosure also provides an imaging apparatus and an image projection apparatus using such an optical system.

An aspect of the present disclosure is directed to an optical system having a reduction conjugate point on a reduction side and a magnification conjugate point on a magnification side that are optically conjugate with each other, the optical system includes:
a prism including a first transmission surface located on the magnification side, a second transmission surface located on the reduction side, and at least three reflection surfaces located on an optical path between the first transmission surface and the second transmission surface;
wherein the prism has a meridional plane through which light rays reflected by the at least three reflection surfaces pass,
wherein the at least three reflection surfaces include a first reflection surface and a second reflection surface in order from the magnification side to the reduction side, and a most reduction-side reflection surface located closest to the reduction side,
wherein an intermediate imaging position having a conjugate relationship with both of the reduction conjugate point and the magnification conjugate point is positioned between the second reflection surface and the most reduction-side reflection surface inside the prism,
wherein the second reflection surface is positioned between the intermediate imaging position and the first reflection surface, and
wherein the first reflection surface is positioned in a region where a plurality of principal rays traveling inside the prism are converged on.

Further, a stereo optical system according to another aspect of the present disclosure, includes a plurality of the above-described optical systems, wherein the second transmission surfaces of the plurality of the optical systems are arranged adjacent to each other.

Further, a stereo imaging apparatus according to another aspect of the present disclosure, includes: the above-described stereo optical system, and an imaging element having a single imaging surface corresponding to the second transmission surfaces and for receiving respective optical images formed by the plurality of the optical systems on a division surface obtained by dividing the imaging surface to convert the images into an electrical image signal.

Still further, an imaging apparatus according to another aspect of the present disclosure includes the above-described optical system and an imaging element that receives an optical image formed by the optical system to convert the optical image into an electrical image signal.

Still further, an image projection apparatus according to another aspect of the present disclosure includes the above-described optical system and an image forming element that generates an image to be projected through the optical system onto a screen.

According to the optical system according to the present disclosure, it can be manufactured with a smaller number of parts, wherein the size and height thereof can be reduced, and a wide-angle design can be easily achieved.

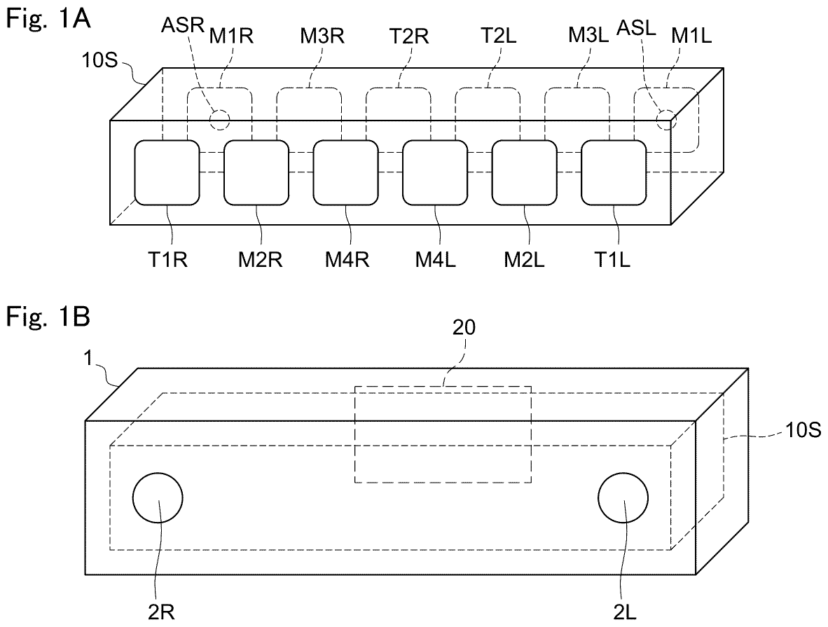

FIG. 1A is an overall schematic diagram illustrating an example of a stereo optical system according to the present disclosure, and FIG. 1B is an overall schematic diagram illustrating an example of a stereo imaging apparatus according to the present disclosure.

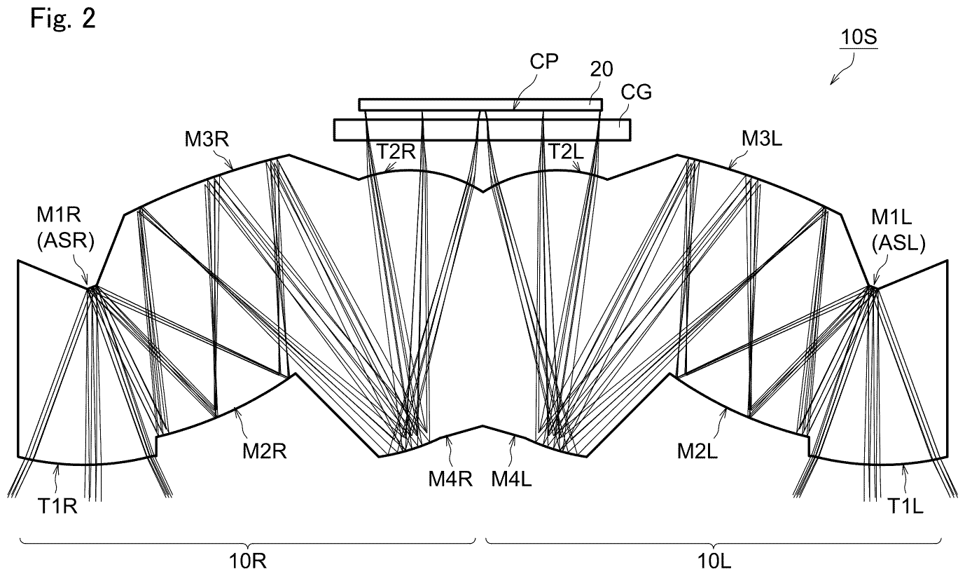

FIG. 2 is a plan view illustrating an example of the stereo optical system.

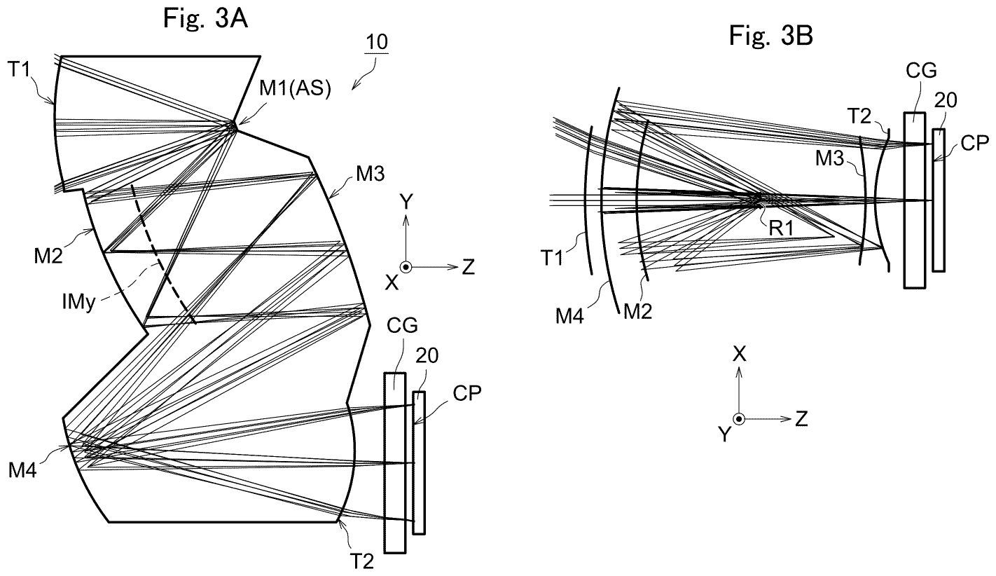

FIGS. 3A and 3B are layout diagrams illustrating an optical system according to Example 1.

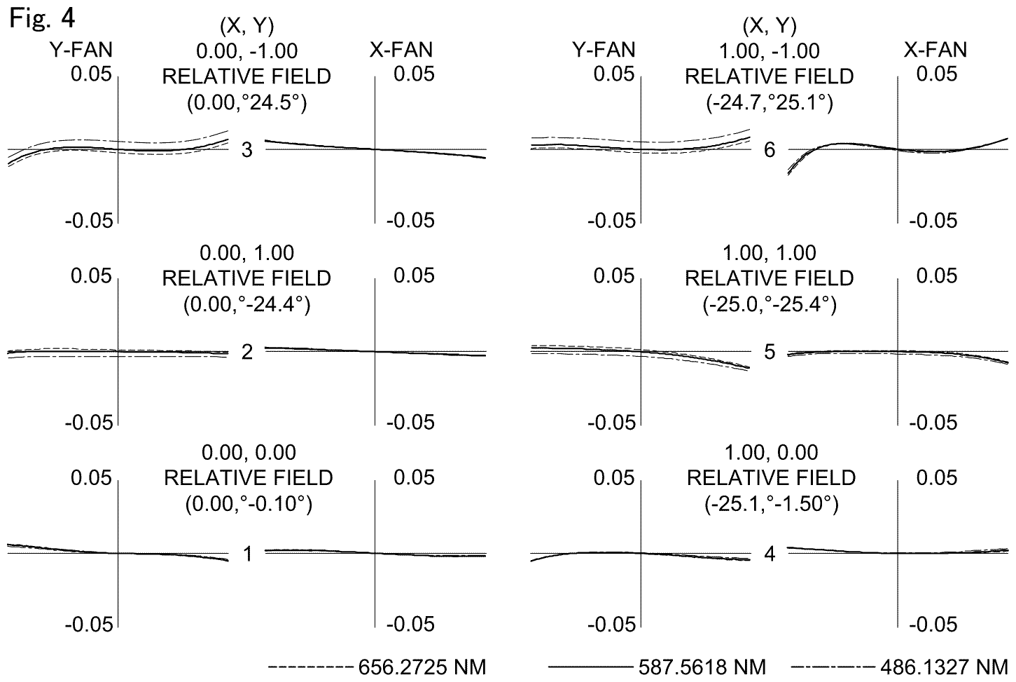

FIG. 4 is a lateral aberration diagram of the optical system according to Example 1.

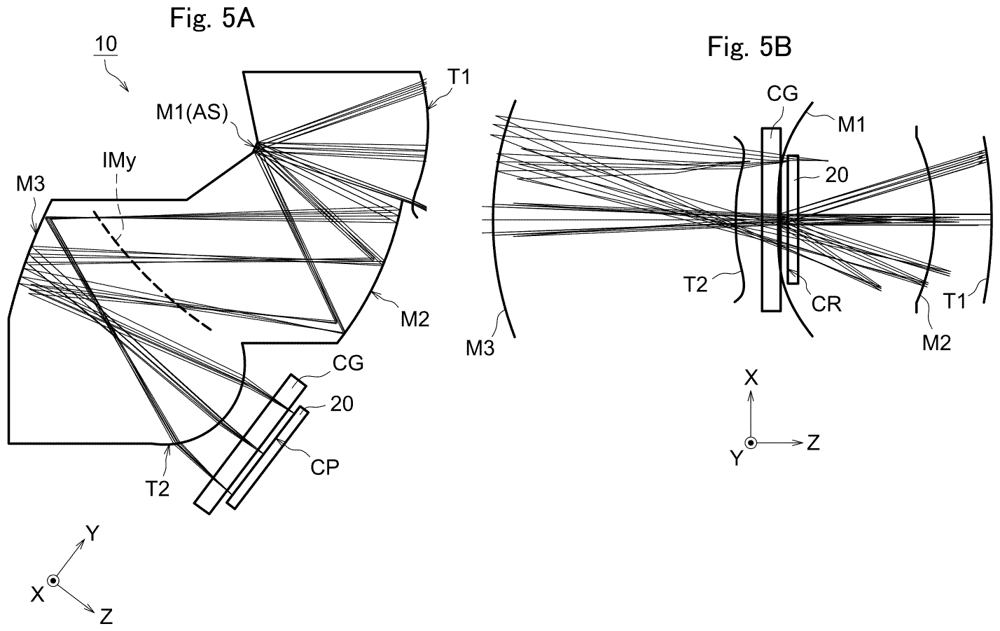

FIGS. 5A and 5B are layout diagrams illustrating an optical system according to Example 2.

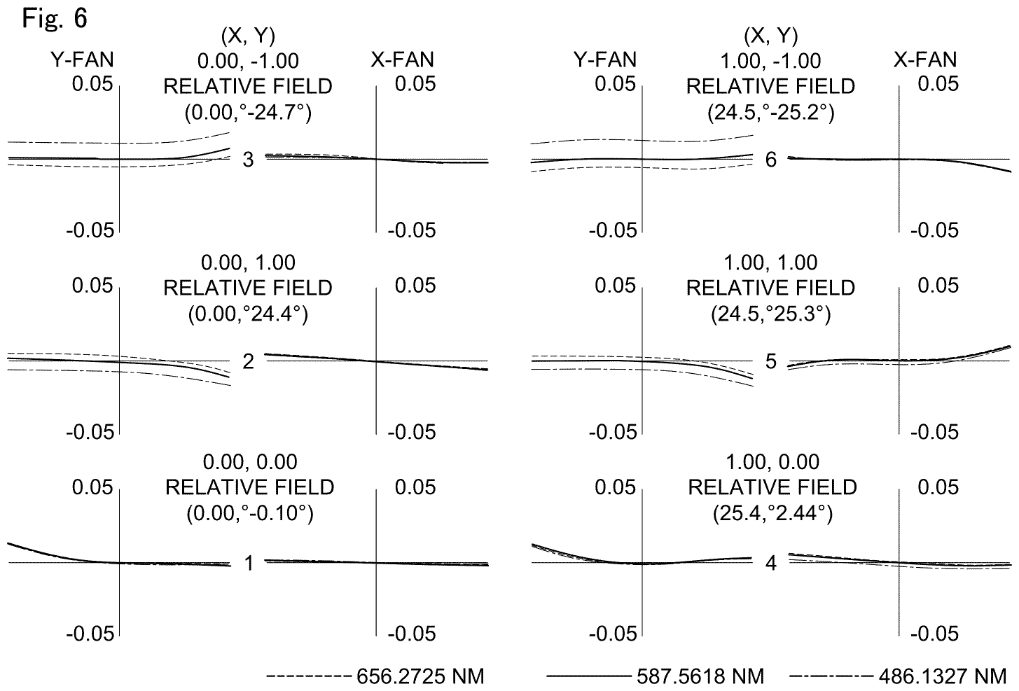

FIG. 6 is a lateral aberration diagram of the optical system according to Example 2.

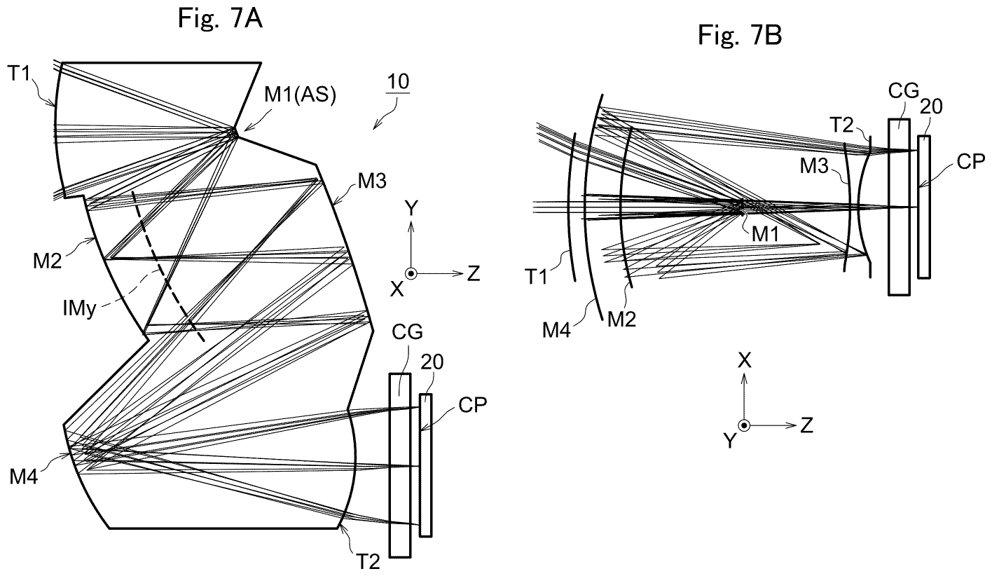

FIGS. 7A and 7B are layout diagrams illustrating an optical system according to Example 3.

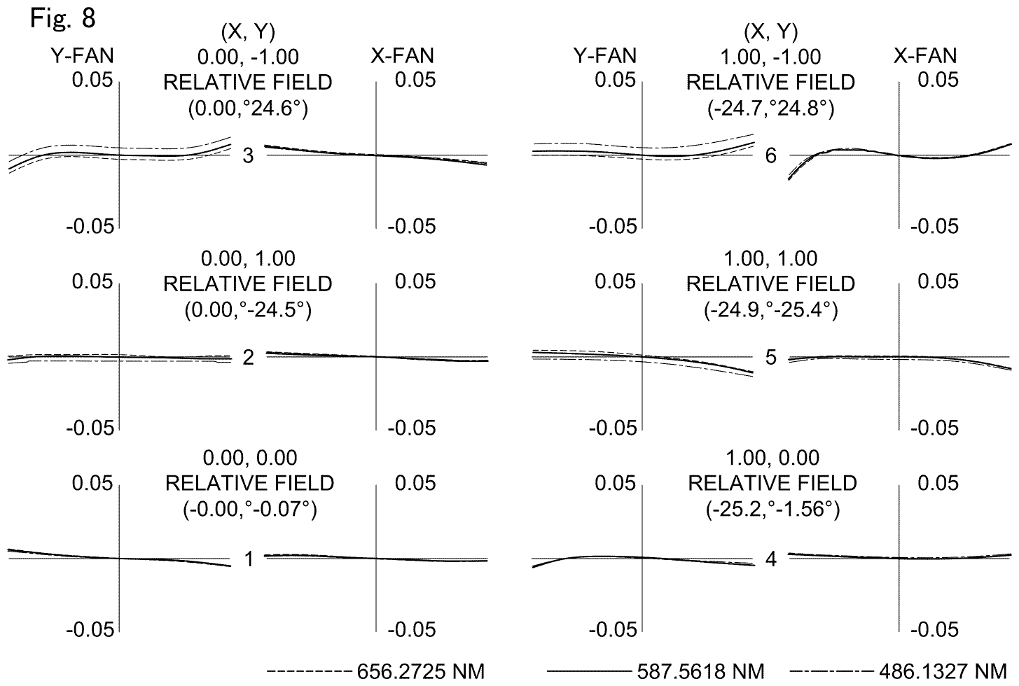

FIG. 8 is a lateral aberration diagram of the optical system according to Example 3.

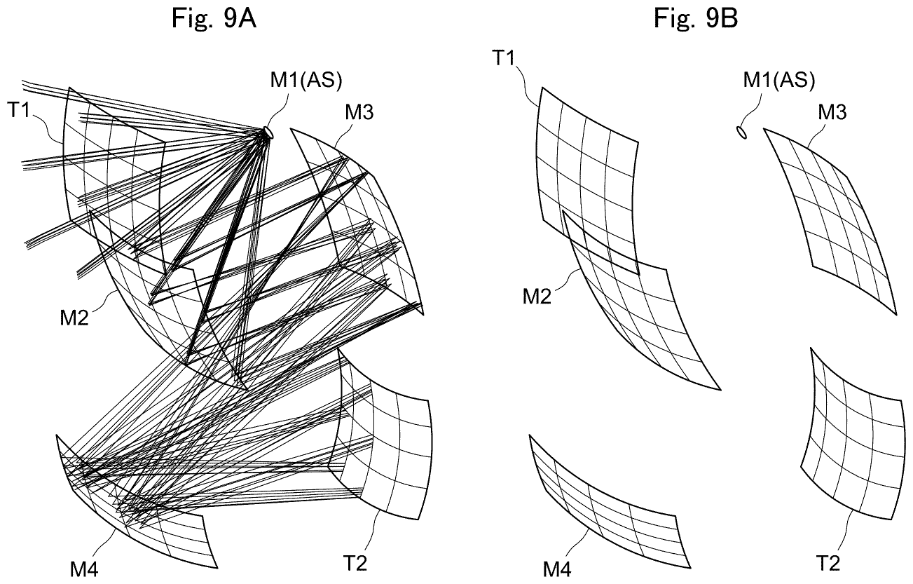

FIG. 9A is a schematic perspective view illustrating some light fluxes passing through the prism of the optical system according to Example 1. FIG. 9B is a schematic perspective view illustrating a three-dimensional shape of each of the transmission surfaces and each of the reflection surfaces of the prism.

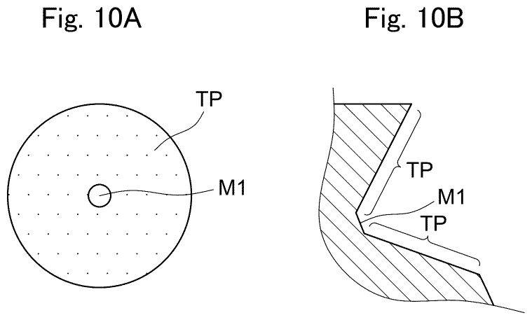

FIG. 10A is a plan view illustrating the first reflection surface and the surrounding region thereof, and

FIG. 10B is a cross-sectional view thereof.

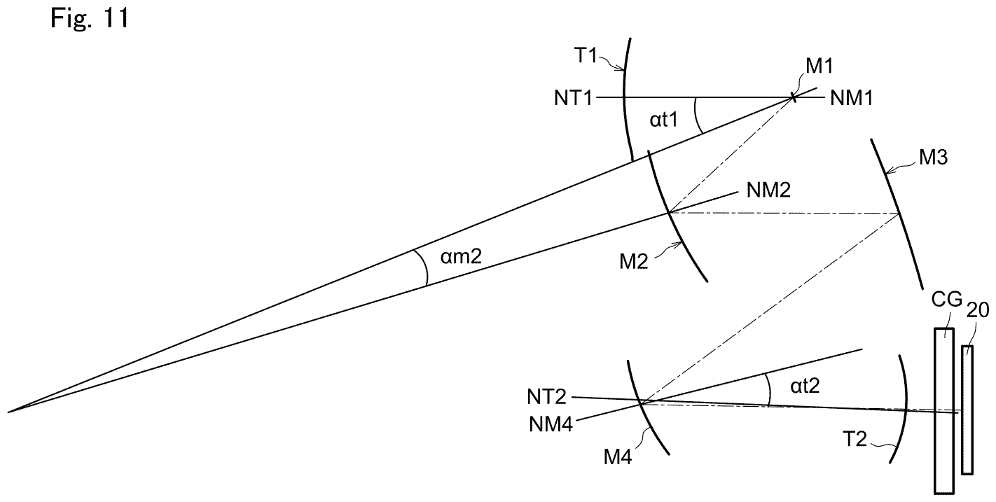

FIG. 11 is an explanatory view illustrating definitions of angles αt1, αm2 and αt2.

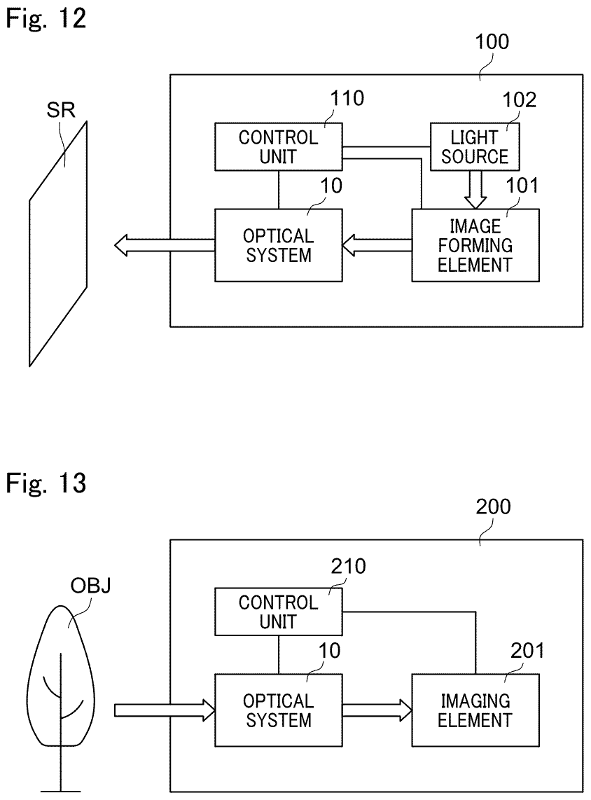

FIG. 12 is a block diagram showing an example of the image projection apparatus according to the present disclosure.

FIG. 13 is a block diagram showing an example of the imaging apparatus according to the present disclosure.

### DETAILED DESCRIPTION

Hereinafter, embodiments are described in detail with reference to the drawings as appropriate. However, unnecessarily detailed descriptions may be omitted. For example, detailed descriptions of well-known items or redundant descriptions of substantially the same configurations may be omitted. This is to prevent the following description from being unnecessarily redundant and to facilitate understanding by those skilled in the art.

It should be noted that the applicant provides the accompanying drawings and the following description for those skilled in the art to fully understand the present disclosure, and it is not intended to limit the subject matter described in the claims thereby.

Each example of an optical system according to the present disclosure is described below. The optical system according to the present disclosure can be used in an imaging apparatus that collects light emitted from an object located on an extended line on the magnification side and forms an optical image of the object on the imaging surface of an imaging element located on the reduction side.

In particular, the optical system according to the present disclosure can be used in a stereo optical system and a stereo imaging device for capturing a stereogram that allows an image to be recognized as a three-dimensional object by utilizing binocular parallax.

Further, the optical system according to the present disclosure can be used for magnifying the original image on the image forming element, such as liquid crystal or digital micromirror device (DMD), arranged on the reduction side to project the image onto the screen (not shown), which is arranged on an extension line on the magnification side. However, a projection surface is not limited to the screen. Examples of the projection surface includes walls, ceilings, floors, windows, etc. in houses, stores, or vehicles and airplanes used as means for transportation.

### First Embodiment

FIG. 1A is an overall schematic diagram illustrating an example of a stereo optical system according to the present disclosure, and FIG. 1B is an overall schematic diagram illustrating an example of a stereo imaging apparatus according to the present disclosure. FIG. 2 is a plan view illustrating an example of the stereo optical system. The stereo imaging apparatus 1 includes a stereo optical system 10S including a free-form surface prism and an imaging element 20 for receiving an optical image of an object formed by the stereo optical system 20 to convert the image into an electrical image signal. The stereo imaging apparatus 1 is generally provided with two imaging windows 2L and 2R separated by a distance of a baseline length that causes binocular parallax.

The stereo optical system 10S is configured by integrating two right and left prisms 10L and 10R. As a method of integrating the prisms, a) a method of bonding two separately manufactured prisms, and b) a method of simultaneously integrally molding the prisms with a mold or the like can be employed.

By way of example, the left prism 10L is provided with a first transmission surface T1L, a first reflection surface M1L, a second reflection surface M2L, a third reflection surface M3L, a fourth reflection surface M4L, and a second transmission surface T2L. The right prism 1CR is provided with a first transmission surface T1R, a first reflection surface M1R, a second reflection surface M2R, a third reflection surface M3R, a fourth reflection surface M4R, and a second transmission surface T2R. The two second transmission surfaces T2L and T2R are arranged adjacent to each other. A single imaging element 20 is located behind the two second transmission surfaces T2L and T2R, the single imaging element 20 having a single imaging surface corresponding to the second transmission surfaces T2L and T2R and receiving respective optical images from the two second transmission surfaces T2L and T2R on a division surface obtained by dividing the imaging surface. Note that a plurality of imaging elements having a single imaging surface may be provided instead of the single imaging element 20.

Light rays emitted from an object are incident on the respective imaging windows 2L and 2R, and then pass through the first transmission surfaces T1L and T1R, and then are reflected inside the prism, and then are emitted from the second transmission surfaces T2L and T2R, and then pass through a cover glass CG to form images on the imaging surface of the imaging element 20. This imaging surface corresponds to a reduction conjugate point on the reduction side, and the object corresponds to a magnification conjugate point on the magnification side.

Integration of the two prisms 10L and 1CR makes it possible to reduce a change in viewing angle due to an error that may take place when the two optical systems are attached.

### Second Embodiment

Hereinafter, an optical system according to a second embodiment of the present disclosure will be described below with reference to FIGS. 3 to 11.

### Example 1

FIGS. 3A and 3B are layout diagrams illustrating an optical system 10 according to Example 1. The optical system 10 corresponds to the respective prisms 10L and 1CR illustrated in FIG. 2. The optical system 10 has a magnification conjugate point (not shown, surface number S1) on the magnification side positioned on the left side in the drawing and a reduction conjugate point CP (surface number S21) on the reduction side positioned on the right side in the drawing (for surface numbers S1, S21, etc., see numerical examples as described later).

The image region on the conjugate plane including the reduction conjugate point CP may be defined as a reduction-side rectangular region having a longitudinal direction (X-direction) and a lateral direction (Y-direction). In addition, another image region on the conjugate plane including the magnification conjugate point may be also defined as a magnification-side rectangular region having a longitudinal direction and a lateral direction. The reduction-side rectangular region and the magnification-side rectangular region have an optically conjugate image forming relationship. The principal ray travels along an optical axis parallel to the normal direction of the reduction-side rectangular region. The reduction-side rectangular region may have an aspect ratio of, for example, 3:2, 4:3, 16:9, 16:10, 256:135, and the like. The reduction-side rectangular region corresponds to an imaging area of an imaging element in the case of an imaging apparatus, and also corresponds to an image display area of an image forming element in the case of an image projection apparatus.

An intermediate imaging position that is conjugate with both of the reduction conjugate point CP and the magnification conjugate point is located inside the optical system 10. This intermediate imaging position appears as a Y-direction intermediate image IMy on the meridional plane (YZ-plane), and also appears as an X-direction intermediate image IMx on the sagittal plane (XY-plane). In FIGS. 3A, 3B, 5A, 5B, 7A and 7B, only the Y-direction intermediate image IMy in the meridional plane is illustrated, and the X-direction intermediate image IMx in the sagittal plane is not illustrated. When any one of the reflection surfaces is curved, the reflection position of the light flux located in the meridional plane and the reflection position of the light flux located outside the meridional plane are shifted relative to each other.

The optical system 10 includes a prism that can be made of a transparent medium, for example, glass, synthetic resin, or the like, and a cover glass CG located in front of the imaging element 20. The cover glass CG may be formed of a flat plate having zero optical power, and may be omitted instead. The prism has a first transmission surface T1 located on the magnification side, a second transmission surface T2 located on the reduction side, and four reflection surfaces, i.e., first reflection surfaces M1, second reflection surfaces M2, third reflection surfaces M3, and fourth reflection surfaces M4 located on the optical path between the first transmission surface T1 and the second transmission surface T2. The first transmission surface T1 (surface number S1) has a free-form surface shape with a convex surface facing the magnification side. The first reflection surface M1 (surface number S4) has a substantially flat free-form surface shape having an optical power of zero. The second reflection surface M2 (surface number S8) has a free-form surface shape with a concave surface facing a direction in which a light ray incident on the second reflection surface M2 is reflected. The third reflection surface M3 (surface number S12) has a free-form surface shape with a concave surface facing a direction in which a light ray incident on the third reflection surface M3 is reflected. The fourth reflection surface M4 (surface number S16) has a free-form surface shape with a concave surface facing a direction in which a light ray incident on the fourth reflection surface M4 is reflected. The second transmission surface T2 (surface number S18) has a free-form surface shape with a convex surface facing the reduction side. In the present example, the fourth reflection surface M4 corresponds to the most reduction-side reflection surface.

FIG. 9A is a schematic perspective view illustrating some light fluxes passing through the prism of the optical system 10 according to Example 1. FIG. 9B is a schematic perspective view illustrating a three-dimensional shape of each of the transmission surfaces and each of the reflection surfaces of the prism. In the case of the imaging apparatus, light rays emitted from the magnification-side rectangular region pass through the first transmission surface T1, and then are sequentially reflected by the first to fourth reflection surfaces M1 to M4, and then pass through the second transmission surface T2, and then pass through the cover glass CG, and then are focused on the imaging element 20. In this case, the first reflection surface M1 is positioned in a region where a plurality of principal rays traveling inside the prism are converged on. The first reflection surface M1 can also function as a stop AS for eliminating light rays traveling to a surrounding region of the first reflection surface M1 and exploiting only light reflected by the first reflection surface M1.

FIG. 4 is a lateral aberration diagram of the optical system 10 according to Example 1. Each graph corresponds to normalized coordinates (X, Y)=(0, 0), (0, 1), (0, −1), (1, 0), (1, 1), and (1, −1) of the reduction-side rectangular region at the reduction conjugate point. The three wavelengths used for the calculation are 656.2725 nm, 587.5618 nm, and 486.1327 nm. From these graphs, it can be found that a clear light spot is obtained in the reduction-side rectangular region (for example, the imaging surface), and excellent optical performance is exhibited.

### Example 2

FIGS. 5A and 5B are layout diagrams illustrating an optical system 10 according to Example 2. The optical system 10 corresponds to the respective prisms 10L and 1CR illustrated in FIG. 2. The optical system 10 has a magnification conjugate point (not shown, surface number S1) on the magnification side positioned on the upper right side of the drawing and a reduction conjugate point CP (surface number S21) on the reduction side positioned on the lower right side of the drawing (for surface numbers S1, S21, etc., see numerical examples as described later). The optical system 10 has a configuration similar to that of Example 1, but hereinafter, the description overlapping with that of Example 1 may be omitted.

An intermediate imaging position that is conjugate with both of the reduction conjugate point CP and the magnification conjugate point is located inside the optical system 10. This intermediate imaging position appears as a Y-direction intermediate image IMy on the meridional plane (YZ-plane), and also appears as an X-direction intermediate image IMx on the sagittal plane (XY-plane).

The optical system 10 includes a prism formed of a transparent medium and a cover glass CG. The prism has a first transmission surface T1 located on the magnification side, a second transmission surface T2 located on the reduction side, and three reflection surfaces, i.e., first reflection surfaces M1, second reflection surface M2, and third reflection surface M3 located on the optical path between the first transmission surface T1 and the second transmission surface T2. The first transmission surface T1 (surface number S1) has a free-form surface shape with a convex surface facing the magnification side. The first reflection surface M1 (surface number S4) has a substantially flat free-form surface shape having an optical power of zero. The second reflection surface M2 (surface number S8) has a free-form surface shape with a concave surface facing a direction in which a light ray incident on the second reflection surface M2 is reflected. The third reflection surface M3 (surface number S12) has a free-form surface shape with a concave surface facing a direction in which a light ray incident on the third reflection surface M3 is reflected. The second transmission surface T2 (surface number S14) has a free-form surface shape with a convex surface facing the reduction side. In the present example, the third reflection surface M3 corresponds to the most reduction-side reflection surface.

In the case of the imaging apparatus, light rays emitted from the magnification-side rectangular region pass through the first transmission surface T1, and then are sequentially reflected by the first to third reflection surfaces M1 to M3, and then pass through the second transmission surface T2, and then pass through the cover glass CG, and then are focused on the imaging element 20. In this case, the first reflection surface M1 is positioned in a region where a plurality of principal rays traveling inside the prism are converged on. The first reflection surface M1 can also function as a stop AS for eliminating light rays traveling to a surrounding region of the first reflection surface M1 and exploiting only light reflected by the first reflection surface M1.

FIG. 6 is a lateral aberration diagram of the optical system 10 according to Example 2. Normalized coordinates and wavelengths of each graph are similar to those in Example 1. From these graphs, it can be found that a clear light spot is obtained in the reduction side rectangular region (for example, the imaging surface), and excellent optical performance is exhibited.

### Example 3

FIGS. 7A and 7B are layout diagrams illustrating an optical system 10 according to Example 3. The optical system 10 corresponds to the respective prisms 10L and 1CR illustrated in FIG. 2. The optical system 10 has a magnification conjugate point (not shown, surface number S1) on the magnification side positioned on the left side in the drawing and a reduction conjugate point CP (surface number S21) on the reduction side positioned on the right side in the drawing (for surface numbers S1, S21, etc., see numerical examples as described later). The optical system 10 has a configuration similar to that of Example 1, but hereinafter, the description overlapping with that of Example 1 may be omitted.

An intermediate imaging position that is conjugate with both of the reduction conjugate point CP and the magnification conjugate point is located inside the optical system 10. This intermediate imaging position appears as a Y-direction intermediate image IMy on the meridional plane (YZ-plane), and also appears as an X-direction intermediate image IMx on the sagittal plane (XY-plane).

The optical system 10 includes a prism formed of a transparent medium and a cover glass CG. The prism has a first transmission surface T1 located on the magnification side, a second transmission surface T2 located on the reduction side, and four reflection surfaces, i.e., first reflection surfaces M1, second reflection surfaces M2, third reflection surfaces M3, and fourth reflection surfaces M4 located on the optical path between the first transmission surface T1 and the second transmission surface T2. The first transmission surface T1 (surface number S1) has a free-form surface shape with a convex surface facing the magnification side. The first reflection surface M1 (surface number S4) has a substantially flat free-form surface shape having an optical power of zero. The second reflection surface M2 (surface number S8) has a free-form surface shape with a concave surface facing a direction in which a light ray incident on the second reflection surface M2 is reflected. The third reflection surface M3 (surface number S12) has a free-form surface shape with a concave surface facing a direction in which a light ray incident on the third reflection surface M3 is reflected. The fourth reflection surface M4 (surface number S16) has a free-form surface shape with a concave surface facing a direction in which a light ray incident on the fourth reflection surface M4 is reflected. The second transmission surface T2 (surface number S18) has a free-form surface shape with a convex surface facing the reduction side. In the present example, the fourth reflection surface M4 corresponds to the most reduction-side reflection surface.

In the case of the imaging apparatus, light rays emitted from the magnification-side rectangular region pass through the first transmission surface T1, and then are sequentially reflected by the first to fourth reflection surfaces M1 to M4, and then pass through the second transmission surface T2, and then pass through the cover glass CG, and then are focused on the imaging element 20. In this case, the first reflection surface M1 is positioned in a region where a plurality of principal rays traveling inside the prism are converged on. The first reflection surface M1 can also function as a stop AS for eliminating light rays traveling to a surrounding region of the first reflection surface M1 and exploiting only light reflected by the first reflection surface M1.

FIG. 8 is a lateral aberration diagram of the optical system 10 according to Example 3. Normalized coordinates and wavelengths of each graph are similar to those in Example 1. From these graphs, it can be found that a clear light spot is obtained in the reduction side rectangular region (for example, the imaging surface), and excellent optical performance is exhibited.

In the optical system 10 according to each of Examples 1 to 3, the prism integrates the first transmission surface T1, the second transmission surface T2, either the first to fourth reflection surfaces M1 to M4 (Examples 1 and 3), or the first to third reflection surfaces M1 to M3 (Example 2) all-in-one, so that assembly adjustment between optical components can be reduced, and manufacturing cost can be suppressed. In addition, the optical surface having an optical power of the prism does not have an axis that is rotationally symmetric, that is, the optical surface is formed as a free-form surface having different curvatures along the X-axis and the Y-axis perpendicular to the surface normal. By using a free-form surface capable of defining different curvatures along the X-axis and the Y-axis for the optical surface of the prism, the degree of freedom for correcting distortion satisfactorily increases, so that the optical system can be downsized.

Next, conditions that can be satisfied by the optical system according to the present embodiment will be described below. Note that although a plurality of conditions are defined for the optical system according to each of the examples, all of these plurality of conditions may be satisfied, or the individual conditions may be satisfied to obtain the corresponding effects.

The optical system 10 according to the present embodiment is an optical system having a reduction conjugate point on a reduction side and a magnification conjugate point on a magnification side that are optically conjugate with each other, the optical system including a prism including a first transmission surface T1 located on the magnification side, a second transmission surface T2 located on the reduction side, and at least three reflection surfaces M1 to M4 located on an optical path between the first transmission surface T1 and the second transmission surface T2. The prism has a meridional plane through which light rays reflected by the at least three reflection surfaces M1 to M4 pass. The at least three reflection surfaces include a first reflection surface M1 and a second reflection surface M2 in order from the magnification side to the reduction side, and a most reduction-side reflection surface M3 or M4 located closest to the reduction side. An intermediate imaging position having a conjugate relationship with both of the reduction conjugate point CP and the magnification conjugate point is positioned between the second reflection surface M2 and the most reduction-side reflection surface M3 or M4 inside the prism. The second reflection surface M2 is positioned between the intermediate imaging position and the first reflection surface M1. The first reflection surface M1 is positioned in a region where a plurality of principal rays traveling inside the prism are converged on.

With such a configuration, the first reflection surface can function as an aperture of a stop that can adjust the amount of light passing through the optical system. Therefore, the light amount at either the reduction conjugate point or the magnification conjugate point can be optimized, thereby preventing passage of stray light or off-axis light. In addition, the plurality of transmission surfaces and the plurality of reflection surfaces can be integrated all-in-one, so that the height of the prism can be reduced with a smaller number of members, the effective diameter and the size can be also reduced, and a wide-angle design can be easily achieved.

The optical system 10 according to the present embodiment may satisfy the following condition (1):

$$- 2. < rxm 1 / rym 1 < 2. \qquad ( 1 )$$

where rxm1 is a x-direction partial radius of curvature at a position where a reference light ray passing through both of a center of the first reflection surface M1 and a center of a conjugate plane including the reduction conjugate point CP passes through the first reflection surface M1,
rym1 is a y-direction partial radius of curvature at the position where the reference light ray passing through both of the center of the first reflection surface M1 and the center of the conjugate plane including the reduction conjugate point CP passes through the first reflection surface M1,
x-direction is a direction perpendicular to the meridional plane, and
y-direction is a direction parallel to the meridional plane and the first reflection surface M1.

Expression (1) optimizes the relationship between the x-direction partial radius of curvature and the y-direction partial radius of curvature of the first reflection surface. The first reflection surface is inclined so that an optical surface (meaning a transmission surface or a reflection surface; the same applies hereinafter) located on the magnification side from the first reflection surface does not spatially interfere with an optical surface located on the reduction side from the first reflection surface. When Expression (1) is satisfied, astigmatism occurring in the optical system can be suppressed. If exceeding the upper limit or falling below the lower limit of Expression (1), astigmatism is deteriorated.

Furthermore, the optical system 10 according to the present embodiment may satisfy the following condition (la):

$$- 1. < rxm 1 / rym 1 < 1. . \qquad ( 1 a )$$

The optical system 10 according to the present embodiment may satisfy the following condition (2):

$$0. < rxt 1 / ryt 1 < 4. \qquad ( 2 )$$

where rxt1 is a x-direction partial radius of curvature at a position where the reference light ray passing through both of the center of the first reflection surface M1 and the center of the conjugate plane including the reduction conjugate point CP passes through the first transmission surface T1,
ryt1 is a y-direction partial radius of curvature at the position where the reference light ray passing through both of the center of the first reflection surface M1 and the center of the conjugate plane including the reduction conjugate point CP passes through the first transmission surface T1,
x-direction is the direction perpendicular to the meridional plane, and
y-direction is the direction parallel to the meridional plane and the first transmission surface T1.

Expression (2) optimizes the relationship between the x-direction partial radius of curvature and the y-direction partial radius of curvature of the first transmission surface. For the reasons described above, the first reflection surface is inclined. When Expression (2) is satisfied, astigmatism occurring in the optical system can be suppressed. If exceeding the upper limit or falling below the lower limit of Expression (2), astigmatism is deteriorated.

Furthermore, the optical system 10 according to the present embodiment may satisfy the following condition (2a):

$$2. < rxt 1 / ryt 1 < 3. . \qquad ( 2 a )$$

The optical system 10 according to the present embodiment may satisfy the following condition (3):

$$- 7. < rxt 2 / ryt 2 < 0. \qquad ( 3 )$$

where rxt2 is a x-direction partial radius of curvature at a position where the reference light ray passing through both of the center of the first reflection surface M1 and the center of the conjugate plane including the reduction conjugate point CP passes through the second transmission surface T2,
ryt2 is a y-direction partial radius of curvature at the position where the reference light ray passing through both of the center of the first reflection surface M1 and the center of the conjugate plane including the reduction conjugate point CP passes through the second transmission surface T2,
x-direction is the direction perpendicular to the meridional plane, and
y-direction is the direction parallel to the meridional plane and the second transmission surface T2.

Expression (3) optimizes the relationship between the x-direction partial radius of curvature and the y-direction partial radius of curvature of the second transmission surface. For the reasons described above, the first reflection surface is inclined. When Expression (3) is satisfied, astigmatism occurring in the optical system can be suppressed. If exceeding the upper limit or falling below the lower limit of Expression (3), astigmatism is deteriorated.

Furthermore, the optical system 10 according to the present embodiment may satisfy the following condition (3a):

$$- 5. < rxt 2 / ryt 2 < - 3. . \qquad ( 3 a )$$

The optical system 10 according to the present embodiment may satisfy the following condition (4):

$$0. < rxm 2 / rym 2 < 3. \qquad ( 4 )$$

where rxm2 is a x-direction partial radius of curvature at a position where the reference light ray passing through both of the center of the first reflection surface M1 and the center of the conjugate plane including the reduction conjugate point CP passes through the second reflection surface M2,
rym2 is a y-direction partial radius of curvature at the position where the reference light ray passing through both of the center of the first reflection surface M1 and the center of the conjugate plane including the reduction conjugate point CP passes through the second reflection surface M2,
x-direction is the direction perpendicular to the meridional plane, and
y-direction is the direction parallel to the meridional plane and the second reflection surface M2.

Expression (4) optimizes the relationship between the x-direction partial radius of curvature and the y-direction partial radius of curvature of the second reflection surface. For the reasons described above, the first reflection surface is inclined. When Expression (4) is satisfied, astigmatism occurring in the optical system can be suppressed. If exceeding the upper limit or falling below the lower limit of Expression (4), astigmatism is deteriorated.

Furthermore, the optical system 10 according to the present embodiment may satisfy the following condition (4a):

$$0. < rxm 2 / rym 2 < 2. . \qquad ( 4 a )$$

The optical system 10 according to the present embodiment may satisfy the following condition (5):

$$0. < rxms / ryms < 3. \qquad ( 5 )$$

where rxms is a x-direction partial radius of curvature at a position where the reference light ray passing through both of the center of the first reflection surface M1 and the center of the conjugate plane including the reduction conjugate point CP passes through the most reduction-side reflection surface M3 or M4,
ryms is a y-direction partial radius of curvature at the position where the reference light ray passing through both of the center of the first reflection surface M1 and the center of the conjugate plane including the reduction conjugate point CP passes through the most reduction-side reflection surface M3 or M4,
x-direction is the direction perpendicular to the meridional plane, and y-direction is the direction parallel to the meridional
plane and the most reduction-side reflection surface M3 or M4.

Expression (5) optimizes the relationship between the x-direction partial radius of curvature and the y-direction partial radius of curvature of the most reduction-side reflection surface. For the reasons described above, the first reflection surface is inclined. When Expression (5) is satisfied, astigmatism occurring in the optical system can be suppressed. If exceeding the upper limit or falling below the lower limit of Expression (5), astigmatism is deteriorated.

Furthermore, the optical system 10 according to the present embodiment may satisfy the following condition (5a):

$$0. < rxms / ryms < 2. . \qquad ( 5 a )$$

The optical system 10 according to the present embodiment may satisfy the following condition (6):

$$5. < \vert α t 1 \vert < 30. \qquad ( 6 )$$

where αt1 is an angle formed between a normal line NT1 of the first transmission surface T1 at the position where the reference light ray passing through both of the center of the first reflection surface M1 and the center of a conjugate plane including the reduction conjugate point CP passes through the first transmission surface T1 and a normal line NM1 of the first reflection surface M1 at the position where the reference light ray passes through the first reflection surface M1 (see FIG. 11 for the angle formed between the respective normal lines).

Expression (6) optimizes the angle between the normal line of the first transmission surface and the normal line of the first reflection surface. If falling below the lower limit of Expression (6), the surfaces spatially interfere with each other. If exceeding the upper limit, it is difficult to manufacture the prism.

Furthermore, the optical system 10 according to the present embodiment may satisfy the following condition (6a):

$$10. < \vert α t 1 \vert < 25. . \qquad ( 6 a )$$

The optical system 10 according to the present embodiment may satisfy the following condition (7):

$$\vert α m 2 \vert < 2. \qquad ( 7 )$$

where αm2 is an angle formed between a normal line of the first reflection surface M1 at the position where the reference light ray passing through both of the center of the first reflection surface M1 and the center of the conjugate plane including the reduction conjugate point CP passes through the first reflection surface M1 and a normal line of the second reflection surface M2 at the position where the reference light ray passes through the second reflection surface M2 (see FIG. 11 for the angle formed between the respective normal lines).

Expression (7) optimizes the angle between the normal line of the first reflection surface and the normal line of the second reflection surface. If exceeding the upper limit of Expression (7), it is difficult to manufacture the prism.

Furthermore, the optical system 10 according to the present embodiment may satisfy the following condition (7a):

$$\vert α m 2 \vert < 1. . \qquad ( 7 a )$$

The optical system 10 according to the present embodiment may satisfy the following condition (8):

$$10. \text{<\textbar} α t 2 \vert < 3 5. \qquad ( 8 )$$

where αt2 is an angle formed between a normal line of the most reduction-side reflection surface M3 or M4 at a position where the reference light ray passing through both of the center of the first reflection surface M1 and the center of a conjugate plane including the reduction conjugate point CP passes through the most reduction-side reflection surface M3 or M4 and a normal line of the second transmission surface T2 at a position where the reference light ray passes through the second transmission surface T2 (see FIG. 11 for the angle formed between the respective normal lines).

Expression (8) optimizes the angle between the normal line of the most reduction-side reflection surface and the normal line of the second transmission surface. If falling below the lower limit of Expression (8), the surfaces spatially interfere with each other. If exceeding the upper limit, it is difficult to manufacture the prism.

Furthermore, the optical system 10 according to the present embodiment may satisfy the following condition (8a):

$$15. 0 < \vert α t 2 \vert < 30. \qquad ( 8 a )$$

The optical system 10 according to the present embodiment may satisfy the following condition (9):

$$0.4 \text{<\textbar} t 1 / t 2 \vert < 0 \text{.90} \qquad ( 9 )$$

where t1 is an interval between the first transmission surface T1 and the first reflection surface M1, and t2 is an interval between the second transmission surface T2 and the most reduction-side reflection surface M3 or M4.

Expression (9) optimizes the interval between the transmission surface and the reflection surface. If falling below the lower limit of Expression (9), the incident angle of the off-axis light ray on the reduction side is increased. If exceeding the upper limit, the size of the first transmission surface becomes too large.

Furthermore, the optical system 10 according to the present embodiment may satisfy the following condition (9a):

$$0.5 \text{<\textbar} t 1 / t 2 \vert < 0 \text{.80} \qquad ( 9 a )$$

In the optical system 10 according to the present embodiment, the first reflection surface M1 may have a reflectance of 80% or more, and a surrounding region of the first reflection surface M1 may have a reflectance of less than 10%.

With such a configuration, ghost light rays traveling to the surrounding region of the first reflection surface can be eliminated, and only the light reflected by the first reflection surface can be exploited.

In the optical system 10 according to the present embodiment, the intermediate imaging position may be positioned between the second reflection surface M2 and the most reduction-side reflection surface M3 or M4.

With such a configuration, the prism can be downsized.

In the optical system 10 according to the present embodiment, the first reflection surface M1 and the surrounding region thereof may not be on the same plane.

With such a configuration, ghost light rays traveling to the surrounding region of the first reflection surface can be efficiently eliminated.

In the optical system 10 according to the present embodiment, the surrounding region may include a conical surface extending from the first reflection surface M1 to the opposite side of the first transmission surface T1.

With such a configuration, ghost light rays traveling to the surrounding region of the first reflection surface can be efficiently eliminated.

In the optical system 10 according to the present embodiment, the surrounding region may be provided with a material or a shape for absorbing or scattering light rays.

With such a configuration, ghost light rays traveling to the surrounding region of the first reflection surface can be efficiently eliminated.

In the optical system 10 according to the present embodiment, the second reflection surface may have a shape with a concave surface facing a direction in which a light ray incident thereon is reflected, and the most reduction-side reflection surface may have a shape with a concave surface facing a direction in which a light ray incident thereon is reflected. With such a configuration, the prism can be downsized.

In the optical system 10 according to the present embodiment, the first transmission surface may have a shape with a convex surface facing the magnification side, and the second transmission surface may have a shape with a convex surface facing the reduction side. With such a configuration, the prism can be downsized.

In the optical system 10 according to the present embodiment, the plurality of principal rays may intersect one another between the most reduction-side reflection surface and the second transmission surface. With such a configuration, the prism can be downsized.

FIG. 10A is a plan view illustrating the first reflection surface and the surrounding region thereof, and FIG. 10B is a cross-sectional view thereof. The first reflection surface M1 is formed of, for example, a circular mirror, and the surrounding region TP thereof has a function of eliminating ghost light rays. Any of the following solutions can be employed, for example, a) the surrounding region TP may have a shape that is not on the same plane as the first reflection surface M1, such as an inclined surface for scattering light rays, b) the surrounding region TP may include a conical surface extending from the first reflection surface M1 to the opposite side of the first transmission surface T1, such as a circular conical surface or a pyramidal surface having an inverted tapered shape for scattering light rays, c) the surrounding region TP may be provided with a material or a shape for absorbing or scattering light rays, such as black painting or wrinkling (fine irregularities) for absorbing or scattering light rays. Any one of these solutions may be employed, and two or more of these solutions may be combined.

Hereinafter, numerical examples of the optical system according to Examples 1 to 3 are described. In each of the numerical examples, in the table, the unit of length is all “mm”, and the unit of angle of view is all “°” (degree). Further, in each of the numerical examples, a radius of curvature (ROC), a surface interval, and a material are shown.

A free-form surface (FFS) shape of the prism optical surface is defined by the following formulas using a local orthogonal coordinate system (x, y, z) with the surface vertex thereof as origin point.

$$z = \frac{{cr}^{2}}{1 + \sqrt{1 - ( 1 + k ) {c}^{2} {r}^{2}}} \underline{γ} + {\sum }_{j = 2}^{137} {C}_{j} {x}^{m} {y}^{n} \qquad [ Mathematical Formula 1 ]$$

$$j = \frac{{( m + n )}^{2} + m + 3 n}{2} + 1 \qquad [ Mathematical Formula 2 ]$$

where, Z is a sag height of a surface as measured in parallel to z-axis, r is a distance in the radial direction (=√(x²+y²)), c is a vertex curvature, k is a conic constant, and C is a coefficient of a monomial X^{m}yⁿ.

### Numerical Example 1

Regarding the optical system of Numerical Example 1 (corresponding to Example 1), Table 1 shows lens data, Table 2 shows Y eccentricity amounts and α rotation amounts of the prism optical surface. Table 3 shows free-form surface shape data of the prism optical surface.

One prism optical surface may have plural surface numbers (For example, the first reflection surface M1 has four surface numbers S4 to S7), which indicates surface numbers used for coordinate transformation between global coordinates and local coordinates during numerical calculation. The term “D.A.R. (decenter and return)” in Tables means coordinate transformation between global coordinates and local coordinates during numerical calculation. In addition, lateral aberration diagrams shown in FIGS. 4, 6 and 8 correspond to image height coordinates (x, y)=(0.000, 0.000), (0.000, 1.9445), (0.000, −1.9445), (1.9445, 0.000), (1.9445, 1.9445), (1.9445, −1.9445) of the reduction-side rectangular region, respectively. The same applies to other numerical examples.

TABLE 1

| LENS DATA | | | | | | | | |
|---|---|---|---|---|---|---|---|---|
| | | SURF. | SURF. | | SURFACE | | REF. | ECCENTRIC |
| | | NO. | TYPE | ROC | INTERVAL | MATERIAL | SURF. | TYPE |
| | | S0 | | | 50 | | | |
| | T1 | S1 | XY- | −54.8718 | 6.0306 | BK7_SCHOTT | | D.A.R. |
| | | | POLY. | | | | | |
| | | S2 | SPH. | | 0.0000 | BK7_SCHOTT | | |
| | | S3 | SPH. | | 0.0000 | BK7_SCHOTT | | NORMAL |
| STOP | M1 | S4 | XY- | | 0.0000 | BK7_SCHOTT | REF. | |
| | | | POLY. | | | | | |
| | | S5 | SPH. | | −6.1490 | BK7_SCHOTT | | NORMAL |
| | | S6 | SPH. | | 0.0000 | BK7_SCHOTT | | |
| | | S7 | SPH. | | 0.0000 | BK7_SCHOTT | | NORMAL |
| | M2 | S8 | XY- | 8.6971 | 0.0000 | BK7_SCHOTT | REF. | D.A.R. |
| | | | POLY. | | | | | |
| | | S9 | SPH. | | 8.1497 | BK7_SCHOTT | | NORMAL |
| | | S10 | SPH. | | 0.0000 | BK7_SCHOTT | | |
| | | S11 | SPH. | | 0.0000 | BK7_SCHOTT | | NORMAL |
| | M3 | S12 | XY- | −6.7242 | 0.0000 | BK7_SCHOTT | REF. | D.A.R. |
| | | | POLY. | | | | | |
| | | S13 | SPH. | | −11.4211 | BK7_SCHOTT | | NORMAL |
| | | S14 | SPH. | | 0.0000 | BK7_SCHOTT | | |
| | | S15 | SPH. | | 0.0000 | BK7_SCHOTT | | NORMAL |
| | M4 | S16 | XY- | 11.6559 | 0.0000 | BK7_SCHOTT | REF. | D.A.R. |
| | | | POLY. | | | | | |
| | | S17 | SPH. | | 9.2890 | BK7_SCHOTT | | NORMAL |
| | T2 | S18 | XY- | 94.2598 | 1.0000 | | | D.A.R. |
| | | | POLY. | | | | | |
| | | S19 | SPH. | | 0.7000 | BK7_SCHOTT | | |
| | | S20 | SPH. | | 0.3000 | | | |

| | | | |
|---|---|---|---|
| I.P. | S21 | SPH. | 0.0000 |

TABLE 2

| | ECCENTRIC | | |
|---|---|---|---|
| α ROTATION | TYPE | Y ECC. | α ROT. |
| 1-R1 | D.A.R. | 0.320 | 0.0 |
| 3 | NORMAL | 0.000 | 22.5 |
| 5 | NORMAL | 0.000 | 22.5 |
| 7 | NORMAL | 0.000 | −22.5 |
| 8-M2 | D.A.R. | 0.094 | 0.0 |
| 9 | NORMAL | 0.000 | −22.5 |
| 11 | NORMAL | 0.000 | 18.5 |
| 12-M3 | D.A.R. | −0.074 | 0.0 |
| 13 | NORMAL | 0.000 | 18.5 |
| 15 | NORMAL | 0.000 | −18.5 |
| 16-M4 | D.A.R. | 0.035 | 0.0 |
| 17 | NORMAL | 0.000 | −18.5 |
| 18-R2 | D.A.R. | 0.457 | 0.0 |

TABLE 3

| FREE−FORM SURFACE | | | | | |
|---|---|---|---|---|---|
| COEFFICIENTS OF XY−POLYNOMIAL | | | | | |
| S1 | | | | | |
| | X\hat{ }0 | X\hat{ }2 | X\hat{ }4 | X\hat{ }6 | X\hat{ }8 |
| Y\hat{ }0 | | 3.6477E−02 | 7.1236E−04 | 7.3297E−04 | −1.0274E−04 |
| Y\hat{ }2 | 8.0095E−02 | −4.0661E−03 | −3.7363E−04 | 1.0206E−04 | 0.0000E+00 |
| Y\hat{ }4 | −4.3127E−04 | 3.6431E−04 | −4.5571E−05 | 0.0000E+00 | 0.0000E+00 |
| Y\hat{ }6 | 8.9485E−05 | 3.5303E−05 | 0.0000E+00 | 0.0000E+00 | 0.0000E+00 |
| Y\hat{ }8 | −7.3362E−05 | 0.0000E+00 | 0.0000E+00 | 0.0000E+00 | 0.0000E+00 |
| S4 | | | | | |
| | X\hat{ }0 | X\hat{ }2 | X\hat{ }4 | X\hat{ }6 | X\hat{ }8 |
| Y\hat{ }0 | | 2.7571E−02 | 5.9766E−03 | 0.0000E+00 | 0.0000E+00 |
| Y\hat{ }2 | −2.0346E−02 | 5.3624E−03 | 0.0000E+00 | 0.0000E+00 | 0.0000E+00 |
| Y\hat{ }4 | 1.6461E−02 | 0.0000E+00 | 0.0000E+00 | 0.0000E+00 | 0.0000E+00 |
| S8 | | | | | |
| | X\hat{ }0 | X\hat{ }2 | X\hat{ }4 | X\hat{ }6 | X\hat{ }8 |
| Y\hat{ }0 | | 3.3767E−03 | −1.7322E−03 | 1.3734E−04 | −4.6737E−06 |
| Y\hat{ }2 | 1.6709E−03 | 5.2236E−05 | −1.2360E−04 | 4.8378E−06 | 0.0000E+00 |
| Y\hat{ }4 | −8.6647E−03 | 2.6249E−05 | 4.3071E−06 | 0.0000E+00 | 0.0000E+00 |
| Y\hat{ }6 | 9.6279E−04 | −4.3181E−06 | 0.0000E+00 | 0.0000E+00 | 0.0000E+00 |
| Y\hat{ }8 | −3.2297E−05 | 0.0000E+00 | 0.0000E+00 | 0.0000E+00 | 0.0000E+00 |
| S12 | | | | | |
| | X\hat{ }0 | X\hat{ }2 | X\hat{ }4 | X\hat{ }6 | X\hat{ }8 |
| Y\hat{ }0 | | 3.6145E−02 | −7.5018E−03 | 1.4245E−03 | 0.0000E+00 |
| Y\hat{ }2 | 6.1618E−02 | −3.5896E−03 | 4.9841E−04 | 0.0000E+00 | 0.0000E+00 |
| Y\hat{ }4 | 6.4764E−05 | 1.8322E−04 | 0.0000E+00 | 0.0000E+00 | 0.0000E+00 |
| Y\hat{ }6 | −9.7117E−06 | 0.0000E+00 | 0.0000E+00 | 0.0000E+00 | 0.0000E+00 |
| S16 | | | | | |
| | X\hat{ }0 | X\hat{ }2 | X\hat{ }4 | X\hat{ }6 | X\hat{ }8 |
| Y\hat{ }0 | | −2.4899E−03 | 5.8298E−04 | −2.4487E−05 | 0.0000E+00 |
| Y\hat{ }2 | −1.3883E−02 | −1.2407E−04 | 2.6088E−05 | 0.0000E+00 | 0.0000E+00 |
| Y\hat{ }4 | −5.8718E−04 | 2.3534E−04 | 0.0000E+00 | 0.0000E+00 | 0.0000E+00 |
| Y\hat{ }6 | 7.7289E−04 | 0.0000E+00 | 0.0000E+00 | 0.0000E+00 | 0.0000E+00 |
| S18 | | | | | |
| | X\hat{ }0 | X\hat{ }2 | X\hat{ }4 | X\hat{ }6 | X\hat{ }8 |
| Y\hat{ }0 | | 2.0544E−02 | 5.3710E−02 | −7.8666E−03 | 0.0000E+00 |
| Y\hat{ }2 | −9.5009E−02 | −2.8733E−03 | 5.3016E−04 | 0.0000E+00 | 0.0000E+00 |
| Y\hat{ }4 | −9.1952E−04 | 5.7366E−04 | 0.0000E+00 | 0.0000E+00 | 0.0000E+00 |
| Y\hat{ }6 | −5.8985E−04 | 0.0000E+00 | 0.0000E+00 | 0.0000E+00 | 0.0000E+00 |

### Numerical Example 2

Regarding the optical system of Numerical Example 2 (corresponding to Example 2), Table 4 shows lens data, Table 5 shows Y eccentricity amounts and α rotation amounts of the prism optical surface. Table 6 shows free-form surface shape data of the prism optical surface.

TABLE 4

| LENS DATA | | | | | | | | |
|---|---|---|---|---|---|---|---|---|
| | | SURF. | SURF. | | SURFACE | | REF. | ECCENTRIC |
| | | NO. | TYPE | ROC | INTERVAL | MATERIAL | SURF. | TYPE |
| | | S0 | | | −50 | | | |
| | T1 | S1 | XY- | −10.0115 | −6.4714 | BK7_SCHOTT | | D.A.R. |
| | | | POLY. | | | | | |
| | | S2 | SPH. | | 0.0000 | BK7_SCHOTT | | |
| | | S3 | SPH. | | 0.0000 | BK7_SCHOTT | | NORMAL |
| STOP | M1 | S4 | XY- | | 0.0000 | BK7_SCHOTT | REF. | |
| | | | POLY. | | | | | |
| | | S5 | SPH. | | 6.6950 | BK7_SCHOTT | | NORMAL |
| | | S6 | SPH. | | 0.0000 | BK7_SCHOTT | | |
| | | S7 | SPH. | | 0.0000 | BK7_SCHOTT | | NORMAL |
| | M2 | S8 | XY- | −18.3731 | 0.0000 | BK7_SCHOTT | REF. | D.A.R. |
| | | | POLY. | | | | | |
| | | S9 | SPH. | | −13.5432 | BK7_SCHOTT | | NORMAL |
| | | S10 | SPH. | | 0.0000 | BK7_SCHOTT | | |
| | | S11 | SPH. | | 0.0000 | BK7_SCHOTT | | NORMAL |
| | M3 | S12 | XY- | 13.0032 | 0.0000 | BK7_SCHOTT | REF. | D.A.R. |
| | | | POLY. | | | | | |
| | | S13 | SPH. | | 9.4380 | BK7_SCHOTT | | NORMAL |
| | T2 | S14 | XY- | 4.0272 | 1.0000 | | | D.A.R. |
| | | | POLY. | | | | | |
| | | S15 | SPH. | | 0.7000 | BK7_SCHOTT | | |
| | | S16 | SPH. | | 0.3000 | | | |

| | | | |
|---|---|---|---|
| I.P. | S21 | SPH. | 0.0000 |

TABLE 5

| | ECCENTRIC | | |
|---|---|---|---|
| α ROTATION | TYPE | Y ECC. | α ROT. |
| 1-R1 | D.A.R. | 0.841 | 0.0 |
| 2 | Non | 0.000 | −22.5 |
| STOP-M1 | Non | 0.000 | −22.5 |
| 6 | Non | 0.000 | 22.5 |
| 8-M2 | D.A.R. | 0.230 | 22.5 |
| 10 | Non | 0.000 | −18.5 |
| 12-M3 | D.A.R. | 0.086 | −18.5 |
| 13 | NORMAL | 0.000 | 18.5 |
| 14-R2 | D.A.R. | 0.523 | 0.0 |

TABLE 6

| FREE−FORM SURFACE | | | | | |
|---|---|---|---|---|---|
| COEFFICIENTS OF XY−POLYNOMIAL | | | | | |
| S1 | | | | | |
| | X\hat{ }0 | X\hat{ }2 | X\hat{ }4 | X\hat{ }6 | X\hat{ }8 |
| Y\hat{ }0 | | 2.9260E−02 | −6.7793E−03 | 1.3264E−03 | −7.7869E−05 |
| Y\hat{ }2 | −2.0714E−02 | −6.2226E−04 | −1.7994E−04 | 2.0302E−05 | 0.0000E+00 |
| Y\hat{ }4 | 5.2302E−03 | −2.2334E−04 | 1.5144E−05 | 0.0000E+00 | 0.0000E+00 |
| Y\hat{ }6 | −1.1293E−03 | 2.7612E−05 | 0.0000E+00 | 0.0000E+00 | 0.0000E+00 |
| Y\hat{ }8 | 8.0755E−05 | 0.0000E+00 | 0.0000E+00 | 0.0000E+00 | 0.0000E+00 |
| S4 | | | | | |
| | X\hat{ }0 | X\hat{ }2 | X\hat{ }4 | X\hat{ }6 | X\hat{ }8 |
| Y\hat{ }0 | | 2.3158E−02 | 3.1974E−03 | 0.0000E+00 | 0.0000E+00 |
| Y\hat{ }2 | 1.0255E−02 | −3.2690E−04 | 0.0000E+00 | 0.0000E+00 | 0.0000E+00 |
| Y\hat{ }4 | −1.8817E−02 | 0.0000E+00 | 0.0000E+00 | 0.0000E+00 | 0.0000E+00 |
| S8 | | | | | |
| | X\hat{ }0 | X\hat{ }2 | X\hat{ }4 | X\hat{ }6 | X\hat{ }8 |
| Y\hat{ }0 | | −7.9393E−02 | 1.0812E−02 | −2.1864E−03 | 1.6224E−04 |
| Y\hat{ }2 | −1.8983E−02 | −4.9395E−04 | 2.6789E−04 | −5.7233E−05 | 0.0000E+00 |
| Y\hat{ }4 | −3.7530E−04 | −2.5523E−05 | −6.0626E−06 | 0.0000E+00 | 0.0000E+00 |
| Y\hat{ }6 | 2.1599E−04 | 3.4721E−06 | 0.0000E+00 | 0.0000E+00 | 0.0000E+00 |
| Y\hat{ }8 | −1.6389E−05 | 0.0000E+00 | | | |
| S12 | | | | | |
| | X\hat{ }0 | X\hat{ }2 | X\hat{ }4 | X\hat{ }6 | X\hat{ }8 |
| Y\hat{ }0 | | 5.7857E−03 | −2.6240E−05 | 8.6837E−06 | −4.7129E−07 |
| Y\hat{ }2 | 4.6390E−04 | 3.7119E−04 | 3.7398E−05 | −2.6701E−06 | 0.0000E+00 |
| Y\hat{ }4 | 4.7049E−05 | −7.6290E−05 | −7.4589E−08 | 0.0000E+00 | 0.0000E+00 |
| Y\hat{ }6 | −1.6425E−04 | 1.2281E−05 | 0.0000E+00 | 0.0000E+00 | 0.0000E+00 |
| Y\hat{ }8 | 4.0518E−05 | 0.0000E+00 | 0.0000E+00 | 0.0000E+00 | 0.0000E+00 |
| S14 | | | | | |
| | X\hat{ }0 | X\hat{ }2 | X\hat{ }4 | X\hat{ }6 | X\hat{ }8 |
| Y\hat{ }0 | | −6.6904E−02 | 1.3580E−02 | −2.8744E−03 | −6.2198E−05 |
| Y\hat{ }2 | −3.4122E−01 | −1.5339E−03 | 3.9012E−03 | 3.6674E−15 | 0.0000E+00 |
| Y\hat{ }4 | 2.5140E−03 | −5.4784E−03 | −4.5958E−04 | 0.0000E+00 | 0.0000E+00 |
| Y\hat{ }6 | 8.8518E−04 | 6.7088E−04 | 0.0000E+00 | 0.0000E+00 | 0.0000E+00 |
| Y\hat{ }8 | −4.0126E−04 | 0.0000E+00 | 0.0000E+00 | 0.0000E+00 | 0.0000E+00 |

Regarding the optical system of Numerical Example 3 (corresponding to Example 3), Table 7 shows lens data, Table 8 shows Y eccentricity amounts and α rotation amounts of the prism optical surface. Table 9 shows free-form surface shape data of the prism optical surface.

TABLE 7

| LENS DATA | | | | | | | | |
|---|---|---|---|---|---|---|---|---|
| | | SURF. | SURF. | | SURFACE | | REF. | ECCENTRIC |
| | | NO. | TYPE | ROC | INTERVAL | MATERIAL | SURF. | TYPE |
| | | S0 | | | 50 | | | |
| | T1 | S1 | XY- | −59.6643 | 5.9781 | BK7_SCHOTT | | D.A.R. |
| | | | POLY. | | | | | |
| | | S2 | SPH. | | 0.0000 | BK7_SCHOTT | | |
| | | S3 | SPH. | | 0.0000 | BK7_SCHOTT | | NORMAL |
| STOP | M1 | S4 | XY- | | 0.0000 | BK7_SCHOTT | REF. | |
| | | | POLY. | | | | | |
| | | S5 | SPH. | | −6.0834 | BK7_SCHOTT | | NORMAL |
| | | S6 | SPH. | | 0.0000 | BK7_SCHOTT | | |
| | | S7 | SPH. | | 0.0000 | BK7_SCHOTT | | NORMAL |
| | M2 | S8 | XY- | 8.7190 | 0.0000 | BK7_SCHOTT | REF. | D.A.R. |
| | | | POLY. | | | | | |
| | | S9 | SPH. | | 8.1564 | BK7_SCHOTT | | NORMAL |
| | | S10 | SPH. | | 0.0000 | BK7_SCHOTT | | |
| | | S11 | SPH. | | 0.0000 | BK7_SCHOTT | | NORMAL |
| | M3 | S12 | XY- | −6.7153 | 0.0000 | BK7_SCHOTT | REF. | D.A.R. |
| | | | POLY. | | | | | |
| | | S13 | SPH. | | −11.2863 | BK7_SCHOTT | | NORMAL |
| | | S14 | SPH. | | 0.0000 | BK7_SCHOTT | | |
| | | S15 | SPH. | | 0.0000 | BK7_SCHOTT | | NORMAL |
| | M4 | S16 | XY- | 11.6000 | 0.0000 | BK7_SCHOTT | REF. | D.A.R. |
| | | | POLY. | | | | | |
| | | S17 | SPH. | | 9.2980 | BK7_SCHOTT | | NORMAL |
| | T2 | S18 | XY- | 181.2785 | 1.0000 | | | D.A.R. |
| | | | POLY. | | | | | |
| | | S19 | SPH. | | 0.7 | BK7_SCHOTT | | |
| | | S20 | SPH. | | 0.3 | | | |

| | | | |
|---|---|---|---|
| I.P. | S21 | SPH. | 0.0000 |

TABLE 8

| | ECCENTRIC | | |
|---|---|---|---|
| α ROTATION | TYPE | Y ECC. | α ROT. |
| 1-R1 | D.A.R. | 0.319 | 0.0 |
| 3 | NORMAL | 0.000 | 22.5 |
| 5 | NORMAL | 0.000 | 22.5 |
| 7 | NORMAL | 0.000 | −22.5 |
| 8-M2 | D.A.R. | 0.094 | 0.0 |
| 9 | NORMAL | 0.000 | −22.5 |
| 11 | NORMAL | 0.000 | 18.0 |
| 12-M3 | D.A.R. | −0.076 | 0.0 |
| 13 | NORMAL | 0.000 | 18.0 |
| 15 | NORMAL | 0.000 | −18.0 |
| 16-M4 | D.A.R. | 0.041 | 0.0 |
| 17 | NORMAL | 0.000 | −18.0 |
| 18-R2 | D.A.R. | 0.443 | 0.0 |

TABLE 9

| FREE−FORM SURFACE | | | | | |
|---|---|---|---|---|---|
| COEFFICIENTS OF XY−POLYNOMIAL | | | | | |
| S1 | | | | | |
| | X\hat{ }0 | X\hat{ }2 | X\hat{ }4 | X\hat{ }6 | X\hat{ }8 |
| Y\hat{ }0 | | 3.8009E−02 | 8.7074E−04 | 6.8981E−04 | −9.6207E−05 |
| Y\hat{ }2 | 8.0296E−02 | −3.8876E−03 | −3.9493E−04 | 1.0074E−04 | 0.0000E+00 |
| Y\hat{ }4 | −5.0615E−04 | 3.6529E−04 | −4.5608E−05 | 0.0000E+00 | 0.0000E+00 |
| Y\hat{ }6 | 1.2832E−04 | 3.8191E−05 | 0.0000E+00 | 0.0000E+00 | 0.0000E+00 |
| Y\hat{ }8 | −8.2114E−05 | 0.0000E+00 | 0.0000E+00 | 0.0000E+00 | 0.0000E+00 |
| S4 | | | | | |
| | X\hat{ }0 | X\hat{ }2 | X\hat{ }4 | X\hat{ }6 | X\hat{ }8 |
| Y\hat{ }0 | | 3.0776E−02 | 5.8880E−03 | 0.0000E+00 | 0.0000E+00 |
| Y\hat{ }2 | −2.0686E−02 | 5.1211E−03 | 0.0000E+00 | 0.0000E+00 | 0.0000E+00 |
| Y\hat{ }4 | 1.6603E−02 | 0.0000E+00 | 0.0000E+00 | 0.0000E+00 | 0.0000E+00 |
| S8 | | | | | |
| | X\hat{ }0 | X\hat{ }2 | X\hat{ }4 | X\hat{ }6 | X\hat{ }8 |
| Y\hat{ }0 | | 3.1844E−03 | −1.5667E−03 | 1.2094E−04 | −3.8202E−06 |
| Y\hat{ }2 | 2.5546E−03 | 1.3174E−04 | −1.2593E−04 | 4.8775E−06 | 0.0000E+00 |
| Y\hat{ }4 | −8.9619E−03 | 8.0808E−07 | 4.3436E−06 | 0.0000E+00 | 0.0000E+00 |
| Y\hat{ }6 | 1.0120E−03 | −1.9922E−06 | 0.0000E+00 | 0.0000E+00 | 0.0000E+00 |
| Y\hat{ }8 | −3.4421E−05 | 0.0000E+00 | 0.0000E+00 | 0.0000E+00 | 0.0000E+00 |
| S12 | | | | | |
| | X\hat{ }0 | X\hat{ }2 | X\hat{ }4 | X\hat{ }6 | X\hat{ }8 |
| Y\hat{ }0 | | 3.5672E−02 | −7.7751E−03 | 1.4710E−03 | 0.0000E+00 |
| Y\hat{ }2 | 6.1429E−02 | −3.6276E−03 | 5.1984E−04 | 0.0000E+00 | 0.0000E+00 |
| Y\hat{ }4 | 9.7178E−05 | 1.8322E−04 | 0.0000E+00 | 0.0000E+00 | 0.0000E+00 |
| Y\hat{ }6 | −1.2349E−05 | 0.0000E+00 | 0.0000E+00 | 0.0000E+00 | 0.0000E+00 |
| S16 | | | | | |
| | X\hat{ }0 | X\hat{ }2 | X\hat{ }4 | X\hat{ }6 | X\hat{ }8 |
| Y\hat{ }0 | | −2.2106E−03 | 5.7018E−04 | −2.3886E−05 | 0.0000E+00 |
| Y\hat{ }2 | −1.4069E−02 | −1.2686E−04 | 2.5600E−05 | 0.0000E+00 | 0.0000E+00 |
| Y\hat{ }4 | −5.7361E−04 | 2.4490E−04 | 0.0000E+00 | 0.0000E+00 | 0.0000E+00 |
| Y\hat{ }6 | 7.8952E−04 | 0.0000E+00 | 0.0000E+00 | 0.0000E+00 | 0.0000E+00 |
| S18 | | | | | |
| | X\hat{ }0 | X\hat{ }2 | X\hat{ }4 | X\hat{ }6 | X\hat{ }8 |
| Y\hat{ }0 | | 1.6609E−02 | 5.5032E−02 | −7.9320E−03 | 0.0000E+00 |
| Y\hat{ }2 | −9.1342E−02 | −2.2419E−03 | 4.6603E−04 | 0.0000E+00 | 0.0000E+00 |
| Y\hat{ }4 | −1.2854E−03 | 5.4675E−04 | 0.0000E+00 | 0.0000E+00 | 0.0000E+00 |
| Y\hat{ }6 | −6.0713E−04 | 0.0000E+00 | 0.0000E+00 | 0.0000E+00 | 0.0000E+00 |

Table 10 below shows the corresponding values of the respective conditional expressions (1) to (9) in the respective Numerical Examples 1 to 3.

TABLE 10

| | | EXAMPLE 1 | EXAMPLE 2 | EXAMPLE 3 |
|---|---|---|---|---|
| (1) | rxm1/rym1 | −0.74 | 0.44 | −0.67 |
| (2) | rxt1/ryt1 | 2.64 | 2.38 | 2.46 |
| (3) | rxt2/ryt2 | −3.59 | −3.36 | −4.75 |
| (4) | rxm2/rym2 | 0.97 | 0.43 | 0.99 |
| (5) | rxms/ryms | 0.72 | 0.87 | 0.71 |
| (6) | \| αt1 \| | 18.92 | 14.26 | 18.86 |
| (7) | \| αm2 \| | 0.27 | 0.68 | 0.30 |
| (8) | \| αt2 \| | 23.03 | 28.51 | 22.36 |
| (9) | \| t1/t2 \| | 0.65 | 0.69 | 0.64 |

Table 11 below shows the numerical values of the variables included in the respective conditional expressions (1) to (9) in the respective Numerical Examples 1 to 3.

TABLE 11

| | EXAMPLE 1 | EXAMPLE 2 | EXAMPLE 3 |
|---|---|---|---|
| rxt1 | 18.8 | −22.5 | 17.3 |
| rxm1 | 18.1 | 21.6 | 16.2 |
| rxm2 | 8.2 | −4.7 | 8.3 |
| rxms | 12.4 | 11.3 | 12.2 |
| rxt2 | 19.8 | 8.7 | 26.4 |
| ryt1 | 7.1 | −9.4 | 7.0 |
| rym1 | −24.6 | 48.8 | −24.2 |
| rym2 | 8.5 | −10.8 | 8.4 |
| ryms | 17.3 | 12.9 | 17.2 |
| ryt2 | −5.5 | −2.6 | −5.6 |
| t1 | 6.031 | −6.471 | 5.978 |
| t2 | 9.289 | 9.438 | 9.298 |

### Third Embodiment

Hereinafter, a third embodiment of the present disclosure is described with reference to FIG. 12. FIG. 12 is a block diagram showing an example of the image projection apparatus according to the present disclosure. The image projection apparatus 100 includes such an optical system 10 as disclosed in Second Embodiment, an image forming element 101, a light source 102, a control unit 110, and others.

The image forming element 101 is constituted of, for example, liquid crystal or DMD, for generating an image to be projected through the optical system 10 onto a screen SR. The light source 102 is constituted of, for example, light emitting diode (LED) or laser, for supplying light to the image forming element 101. The control unit 110 is constituted of, for example, central processing unit (CPU) or micro-processing unit (MPU), for controlling the entire apparatus and respective components. The optical system 10 may be configured as either an interchangeable lens that can be detachably attached to the image projection apparatus 100 or a built-in lens that is integrated in the image projection apparatus 100.

The image projection apparatus 100 including the optical system 10 according to Second Embodiment can realize projection with a shorter focal length and a larger-sized screen.

### Fourth Embodiment

Hereinafter, a fourth embodiment of the present disclosure is described with reference to FIG. 13. FIG. 13 is a block diagram showing an example of the imaging apparatus according to the present disclosure. The imaging apparatus 200 includes such an optical system 10 as disclosed in Second Embodiment, an imaging element 201, a control unit 210, and others.

The imaging element 201 is constituted of, for example, charge coupled device (CCD) image sensor or complementary metal oxide semiconductor (CMOS) image sensor, for receiving an optical image of an object OBJ formed by the optical system 10 to convert the image into an electrical image signal. The control unit 110 is constituted of, for example, CPU or MPU, for controlling the entire apparatus and respective components. The optical system 10 may be configured as either an interchangeable lens that can be detachably attached to the imaging apparatus 200 or a built-in lens that is integrated in the imaging apparatus 200.

The imaging apparatus 200 including the optical system 10 according to Second Embodiment can realize imaging with a shorter focal length and a larger-sized screen.

As described above, the embodiments have been described to disclose the technology in the present disclosure. To that end, the accompanying drawings and detailed description are provided.

Therefore, among the components described in the accompanying drawings and the detailed description, not only the components that are essential for solving the problem, but also the components that are not essential for solving the problem may also be included in order to exemplify the above-described technology. Therefore, it should not be directly appreciated that the above non-essential components are essential based on the fact that the non-essential components are described in the accompanying drawings and the detailed description.

Further, the above-described embodiments have been described to exemplify the technology in the present disclosure. Thus, various modification, substitution, addition, omission and so on can be made within the scope of the claims or equivalents thereof.

### INDUSTRIAL APPLICABILITY

The present disclosure can be applied to image projection apparatuses such as projectors and head-up displays, and imaging apparatuses such as digital still cameras, digital video cameras, surveillance cameras in surveillance systems, web cameras, and onboard cameras. In particular, the present disclosure can be applied to optical systems that require a high image quality, such as projectors, digital still camera systems, and digital video camera systems.

1. An optical system having a reduction conjugate point on a reduction side and a magnification conjugate point on a magnification side that are optically conjugate with each other, the optical system comprising:
a prism including a first transmission surface located on the magnification side, a second transmission surface located on the reduction side, and at least three reflection surfaces located on an optical path between the first transmission surface and the second transmission surface;
wherein the prism has a meridional plane through which light rays reflected by the at least three reflection surfaces pass,
wherein the at least three reflection surfaces include a first reflection surface and a second reflection surface in order from the magnification side to the reduction side, and a most reduction-side reflection surface located closest to the reduction side,
wherein an intermediate imaging position having a conjugate relationship with both of the reduction conjugate point and the magnification conjugate point is positioned between the second reflection surface and the most reduction-side reflection surface inside the prism,
wherein the second reflection surface is positioned between the intermediate imaging position and the first reflection surface, and
wherein the first reflection surface is positioned in a region where a plurality of principal rays traveling inside the prism are converged on.

2. The optical system according to claim 1, satisfying the following condition (1):
$$- 2 \text{.0} < rxm 1 / rym 1 < 2. \qquad ( 1 )$$
where rxm1 is a x-direction partial radius of curvature at a position where a reference light ray passing through both of a center of the first reflection surface and a center of a conjugate plane including the reduction conjugate point passes through the first reflection surface,
rym1 is a y-direction partial radius of curvature at the position where the reference light ray passing through both of the center of the first reflection surface and the center of the conjugate plane including the reduction conjugate point passes through the first reflection surface,
x-direction is a direction perpendicular to the meridional plane, and
y-direction is a direction parallel to the meridional plane and the first reflection surface.

3. The optical system according to claim 1, satisfying the following condition (2):
$$0. 0 < rxt 1 / ryt 1 < 4. \qquad ( 2 )$$
where rxt1 is a x-direction partial radius of curvature at a position where the reference light ray passing through both of a center of the first reflection surface and a center of the conjugate plane including the reduction conjugate point passes through the first transmission surface,
ryt1 is a y-direction partial radius of curvature at the position where the reference light ray passing through both of the center of the first reflection surface and the center of the conjugate plane including the reduction conjugate point passes through the first transmission surface,
x-direction is a direction perpendicular to the meridional plane, and
y-direction is a direction parallel to the meridional plane and the first transmission surface.

4. The optical system according to claim 1, satisfying the following condition (3):
$$- 7.0 < rxt 2 / ryt 2 < 0. \qquad ( 3 )$$
where rxt2 is a x-direction partial radius of curvature at a position where the reference light ray passing through both of a center of the first reflection surface and a center of the conjugate plane including the reduction conjugate point passes through the second transmission surface,
ryt2 is a y-direction partial radius of curvature at the position where the reference light ray passing through both of the center of the first reflection surface and the center of the conjugate plane including the reduction conjugate point passes through the second transmission surface,
x-direction is a direction perpendicular the meridional plane, and
y-direction is a direction parallel to the meridional plane and the second transmission surface.

5. The optical system according to claim 1, satisfying the following condition (4):
$$0. 0 < rxm 2 / rym 2 < 3. \qquad ( 4 )$$
where rxm2 is a x-direction partial radius of curvature at a position where the reference light ray passing through both of a center of the first reflection surface and a center of the conjugate plane including the reduction conjugate point passes through the second reflection surface,
rym2 is a y-direction partial radius of curvature at the position where the reference light ray passing through both of the center of the first reflection surface and the center of the conjugate plane including the reduction conjugate point passes through the second reflection surface,
x-direction is a direction perpendicular to the meridional plane, and
y-direction is a direction parallel to the meridional plane and the second reflection surface.

6. The optical system according to claim 1, satisfying the following condition (5):
$$0. < rxms / ryms < 3. \qquad ( 5 )$$
where rxms is a x-direction partial radius of curvature at a position where the reference light ray passing through both of a center of the first reflection surface and a center of the conjugate plane including the reduction conjugate point passes through the most reduction-side reflection surface,
ryms is a y-direction partial radius of curvature at the position where the reference light ray passing through both of the center of the first reflection surface and the center of the conjugate plane including the reduction conjugate point passes through the most reduction-side reflection surface,
x-direction is a direction perpendicular to the meridional plane, and
y-direction is a direction parallel to the meridional plane and the most reduction-side reflection surface.

7. The optical system according to claim 1, satisfying the following condition (6):
$$5. \text{<\textbar} α t 1 \vert < 3 0. \qquad ( 6 )$$
where αt1 is an angle formed between a normal line of the first transmission surface at a position where a reference light ray passing through both of a center of the first reflection surface and a center of a conjugate plane including the reduction conjugate point passes through the first transmission surface and a normal line of the first reflection surface at a position where the reference light ray passes through the first reflection surface.

8. The optical system according to claim 1, satisfying the following condition (7):
$$\vert α m 2 \vert < 2. \qquad ( 7 )$$
where αm2 is an angle formed between a normal line of the first reflection surface M1 at a position where a reference light ray passing through both of a center of the first reflection surface and a center of the conjugate plane including the reduction conjugate point passes through the first reflection surface and a normal line of the second reflection surface at a position where the reference light ray passes through the second reflection surface.

9. The optical system according to claim 1, satisfying the following condition (8):
$$10. 0 < \vert α t 2 \vert < 3 5. \qquad ( 8 )$$
where αt2 is an angle formed between a normal line of the most reduction-side reflection surface at a position where a reference light ray passing through both of a center of the first reflection surface and a center of a conjugate plane including the reduction conjugate point passes through the most reduction-side reflection surface and a normal line of the second transmission surface at a position where the reference light ray passes through the second transmission surface.

10. The optical system according to claim 1, satisfying the following condition (9):
$$0.4 \text{<\textbar} t 1 / t 2 \vert < 0 \text{.90} \qquad ( 9 )$$
where t1 is an interval between the first transmission surface and the first reflection surface, and t2 is an interval between the second transmission surface and the most reduction-side reflection surface.

11. The optical system according to claim 1, wherein the first reflection surface has a reflectance of 80% or more, and a surrounding region of the first reflection surface has a reflectance of less than 10%.

12. The optical system according to claim 11, wherein the first reflection surface and the surrounding region thereof are not on the same plane.

13. The optical system according to claim 12, wherein the surrounding region includes a conical surface extending from the first reflection surface to the opposite side of the first transmission surface.

14. The optical system according to claim 12, wherein the surrounding region is provided with a material or a shape for absorbing or scattering light rays.

15. The optical system according to claim 1, wherein the second reflection surface has a shape with a concave surface facing a direction in which a light ray incident thereon is reflected, and the most reduction-side reflection surface has a shape with a concave surface facing a direction in which a light ray incident thereon is reflected.

16. The optical system according to claim 1, wherein the first transmission surface has a shape with a convex surface: facing the magnification side, and the second transmission surface has a shape with a convex surface facing the reduction side.

17. The optical system according to claim 1, wherein the plurality of principal rays intersect one another between the most reduction-side reflection surface and the second transmission surface.

18. A stereo optical system, including a plurality of the optical systems according to claim 1, wherein the second transmission surfaces of the plurality of the optical systems are arranged adjacent to each other.

19. An imaging apparatus comprising:
the optical system according to any claim 1; and
an imaging element that receives an optical image formed by the optical system to convert the optical image into an electrical image signal.

20. An image projection apparatus comprising:
the optical system according to claim 1; and
an image forming element that generates an image to be projected through the optical system onto a screen.
